(19) United States
(12) Patent Application Publication
(10) Pub. No.: US 2013/0045042 A1
(43) Pub. Date: Feb. 21, 2013

(54) Multi-Directional Structural Joint

(71) Applicant: Stuart A. Ohlson, Denver, CO (US)

(72) Inventor: Stuart A. Ohlson, Denver, CO (US)

(21) Appl. No.: 13/213,317

(22) Filed: Aug. 19, 2011

(51) Int. Cl. F16B 7/00

(52) U.S. Cl. 403/171

(57) ABSTRACT

A multi-directional structural joint for interconnecting the ends of tubular structural pipes that contains a base member having rigid intersecting perpendicular planar plates of circular or polygonal shape where each of the plates terminate in a peripheral edge on which are fixedly mounted a plurality of radially positioned and spaced apart cylindrical connecting studs, where the longitudinal axis of each stud is coplanar with the plate on which it is mounted.

### FIELD OF THE INVENTION

The present invention relates to a joint for interconnecting tubular structural members.

### BACKGROUND OF THE INVENTION

Tubular elements or pipes have advantages over other structural forms because of the load-transmitting qualities inherent in their circular cross section and their efficient strength to weight ratio. In the past the failure to employ them extensively in the construction of walls, trusses and truss-like structures was due to the lack of suitable connectors or coupling members for easily and efficiently joining their ends, especially when producing three dimensional frameworks. The object of the present invention is to provide a universal connection joint that enables quick, easy and efficient construction of tubular frameworks.

### SUMMARY OF THE INVENTION

The multi-directional universal structural joint of the present invention includes a base member that comprises intersecting perpendicular planar plates that support on their peripheral edges a plurality of radially mounted cylindrical studs that are disposed for insertion into the hollow interior of tubular structural framing members (pipes) in either a planar or a three dimensional framework. The joint acts to interconnect a plurality of the tubular framing members in order to form a framework for any purpose, but is particularly suited for forming building walls and roof structures for emergency or temporary types of shelter.

### DESCRIPTION OF THE DRAWINGS

FIG. 1 is a perspective view of an exemplary form of the connection joint of the present invention having five stud connectors.

FIG. 2 is a front view of the joint of FIG. 1.

FIG. 3 is a rear view of the joint of FIG. 1.

FIG. 4 is a side view of the joint of FIG. 1.

FIG. 5 is a bottom view of a modified version of the connection joint where portions of the base plates have been removed to form a corner joint having appropriate points of connection for structural tubing. One of the studs is shown with a fragmentary end portion of the pipe to which the stud in connected. The pipe, and its connection to the stud, is typical of all pipe and stud interconnections in all versions of the joint of the present invention. The cross section is taken along lines 5-5 of FIG. 5B.

FIG. 5A is an end view of the embodiment of FIG. 5.

FIG. 5B is a cross sectional view of the tubular element shown in FIG. 5.

FIG. 6 is a front view of fourth exemplary embodiment of the joint where some portion of the base plates have been removed where the connecting requirement is only for a select number of stud connection points.

FIG. 6A is an end view of the embodiment of FIG. 6.

FIG. 7 is a detailed plan view of an exemplary framework utilizing the connection joint of the present invention to interconnect tubular structural elements in the horizontal and vertical planes.

### DETAILED DESCRIPTION

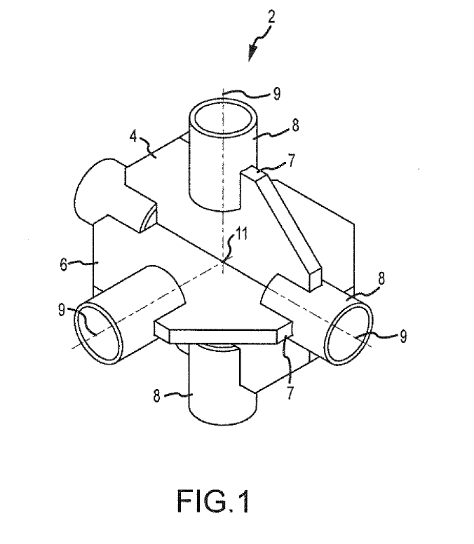

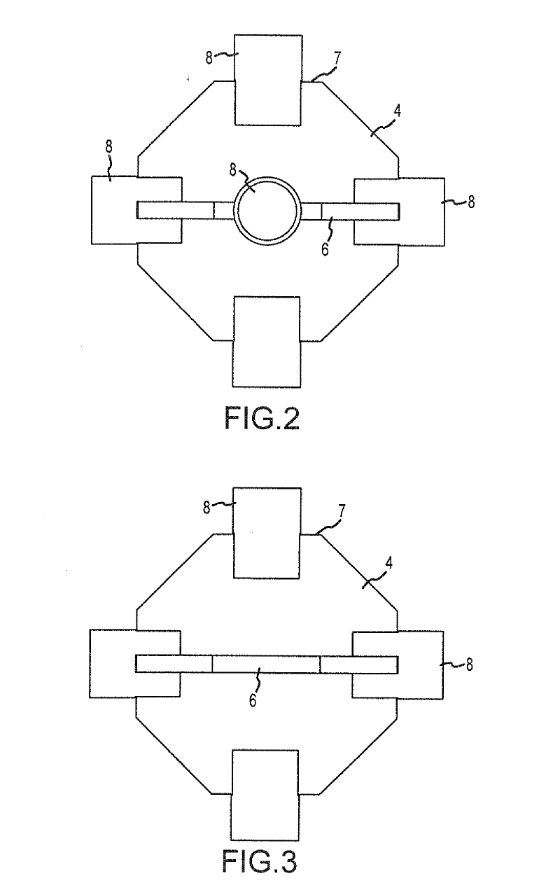

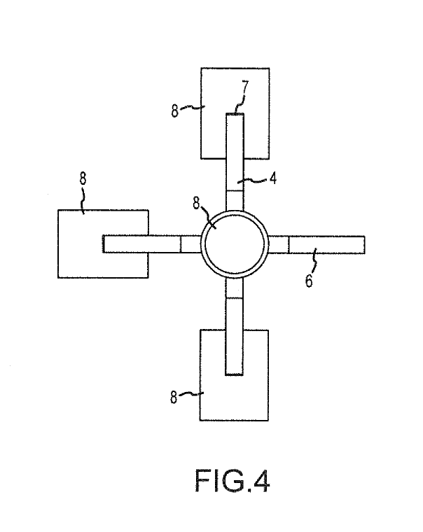

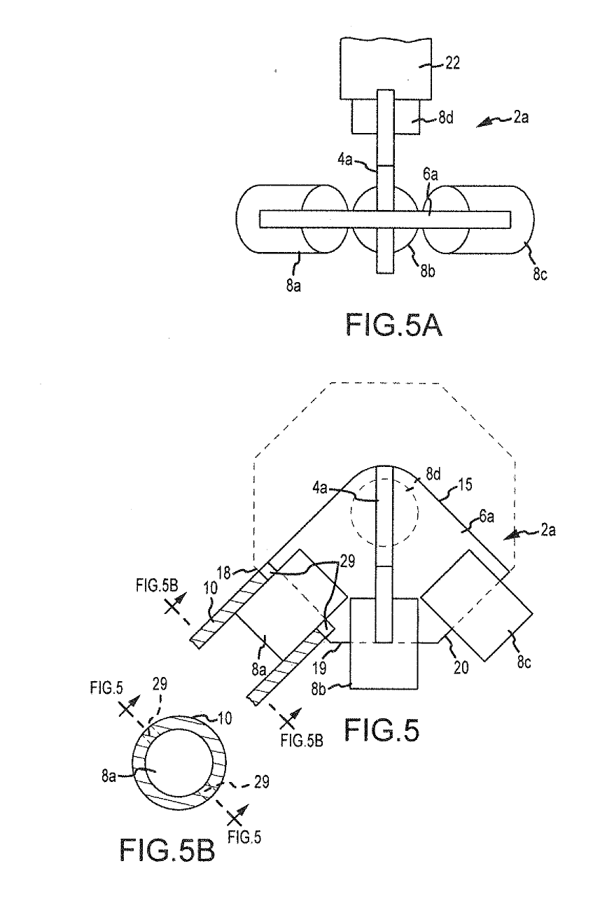

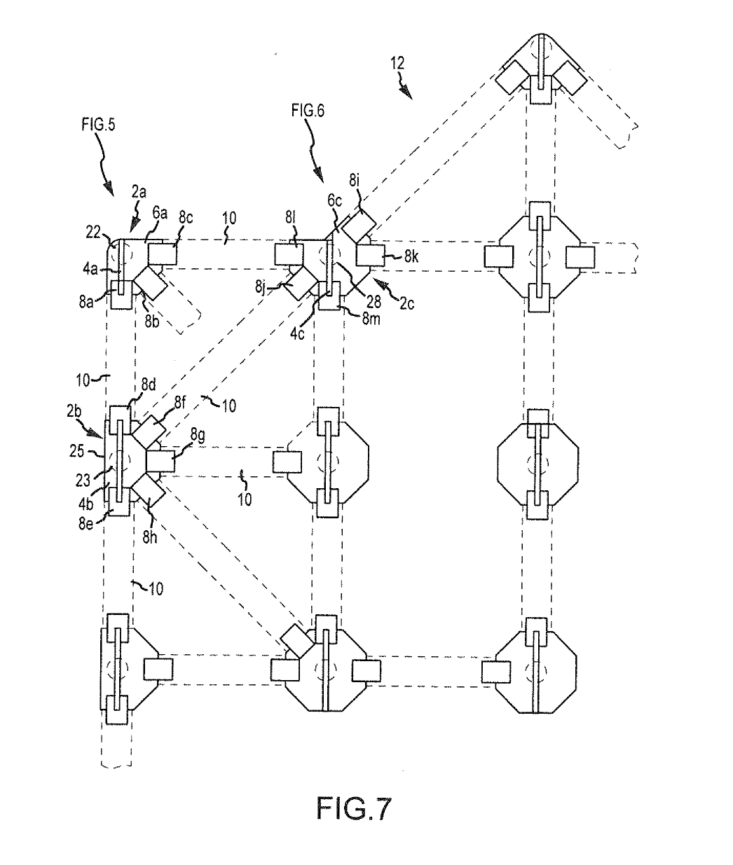

One illustrative and exemplary version of the multi-directional construction joint 2 of the present invention is shown in FIG. 1. All versions of the connecting joint have, as their base, two intersecting mutually perpendicular rigid plates, seen in FIG. 1 and referred to with reference numerals 4 and 6. The periphery of the plates may take any shape from a circle to a polygon but the preferred form is a regular octagon, as seen in FIG. 1, or some section of an octagon, as seen in FIGS. 5, 6 and 7. One or more cylindrical connecting studs 8 are fixedly mounted radially on the peripheral edge 7 of at least one of the plates 4 and 6. The studs 8 in FIGS. 1-4 are shown as tubular, however the studs may be in the form of solid dowels, as they are shown in the embodiments of FIGS. 5-7. For interconnecting the ends of a plurality of pipes 10, each stud 8 is arranged for insertion into the interior of a pipe that is a component of a structural framework, such as the one illustrated in FIG. 7. Preferably, in all versions of the joint, the longitudinal axes 9 of the studs (or radii) lie within the plane of the base plate on which the stud is mounted and all of the radial longitudinal axes intersect at a center point 11.

The term “stud” is defined for purposes of this specification as a cylindrical dowel or tube having a length sufficient to establish a fixed connection with the base plate on which it is mounted and sufficient to establish purchase with the tubular member into which it is inserted. Although the preferred form of the invention utilizes cylindrical dowels or tubes because the preferred form of the structural members in the framework is cylindrical tubing or pipe it is to be understood that the structural members can be rectangular tubes or channels in which case the studs will have a corresponding shape in order to be snuggly received within the structural member.

One of the many benefits and advantages of the structural joint of the present invention is its universality. As seen in FIG. 7, the framework 12 comprises a plurality of tubular pipes 10 that are interconnected by several different modifications of the joint 2, the particular form of the joint being dictated by the configuration of the pipes whose ends must be joined. The joint may connect pipes lying in the same, or first, plane that are either at 90° or 45° angles to each other or the joint may connect pipes lying in planes perpendicular to or at other angles to the first plane.

Referring to FIG. 7, the joint 2a interconnects planar pipes 10 that are at 90° and 45° angles to one another. As seen in more detail in FIGS. 5, 5A and 5B, the plates 4a and 6a are modified octagons with plate 6a having a 90° outside curved surface 15 to accommodate one corner of the framework 12. Connecting studs 8a, 8b and 8c are mounted on the peripheral edges 18, 19 and 20 of the base plate 6a. Only the pipe 10 that is connected to stud 8a is shown in FIG. 5 and that pipe is typical of all pipes in the structure that are interconnected by the joint of the present invention, including the vertical pipes 22, 23 and 28 shown in FIG. 7. Stud 8a is received within the hollow interior of the pipe 10, the terminal end of which contains diametrically opposed slots 29 in the peripheral edge of the pipe. The slots are adapted to snugly receive the peripheral edge 18 of the base plate 6a which connection insures that the pipe will be plumb with the joint. As seen in FIG. 5A, the perpendicular intersecting plate 4a is cut off beneath its intersection with the horizontal plate 6a because there is no requirement for a lower connecting stud in this particular configuration of pipes. The upper half of the plate 4a carries, on its peripheral edge, a connecting stud 8d which is for the purpose of connecting a vertical pipe component 22 of the framework 12.

Referring again to FIG. 7, the connecting joint 2b interconnects pipes 10 that are in longitudinal alignment with one another and also with pipes 10 that are disposed at 90° and 45° angles to the aligned pipes. The joint 2b also interconnects the planar pipes 10 with a vertical pipe component 23. Although the joint 2b is not detailed in another figure of the drawings, it is apparent from the illustration in FIG. 7 that the horizontally disposed plate 4b is slightly more than half an octagon with its cut-off edge 25 positioned to be in alignment with the outside surface of the aligned pipes 10 to provide a smooth base for a wall covering. Five of the octagonal sides of the plate 4b carry connecting studs 8d and 8e that interconnect the aligned pipes and studs 8f, 8g and 8h that interconnect the 90° and 45° pipes 10 that are included in the structure.

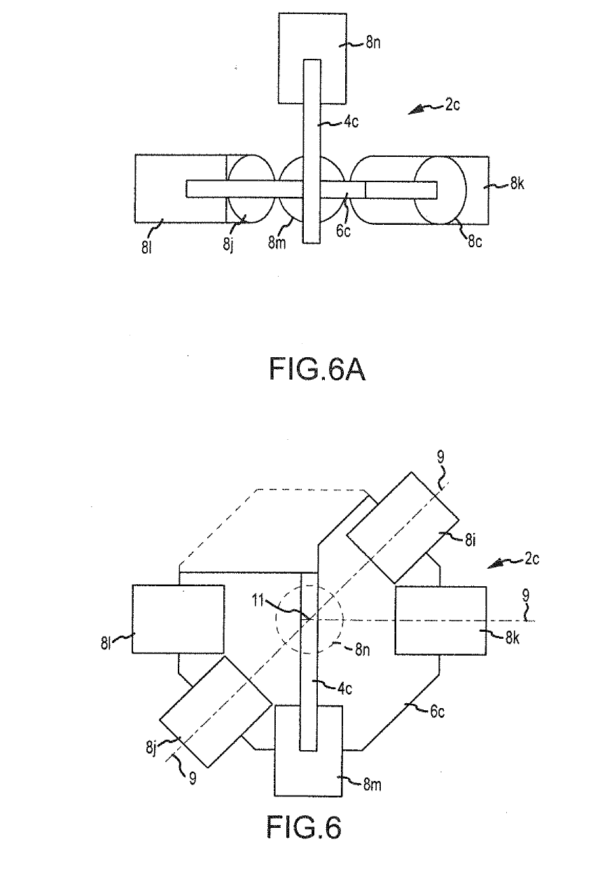

FIGS. 7, 6 and 6A illustrate yet another version of the connecting joint. Utilizing a horizontal base plate 6c and a perpendicular plate 4c, the connecting joint 2c interconnects two sets of horizontally positioned aligned pipes, one set being at a 45° angle with the second set. The intersecting vertical plate 4c of the joint carries on its upper peripheral edge a connecting stud 8n that interconnects a vertical pipe 28 with the other tubular pipes that make connection with the joint 2c. If necessary, in the design of the truss or framework, another stud on an angled side of the vertical plate 4c could connect a pipe having a 45° angle orientation to the plane of the plate 6c.

Other configurations and forms of the connecting joint, as illustrated in FIG. 7, are, from the discussion of the generic version of FIGS. 1-4 and the discussion of the joint variations depicted in FIGS. 5, 6 and 7, self-evident in their detailed construction and purpose.

Fixation of the connection between the studs and the structural pipes may be by a press fit or the fix may be enhanced with glue or other type of fastening device. In any case the connection joint and its multiple variations, as described above, enables unskilled personnel to efficiently and quickly assemble a stable structure having interior and exterior walls and a roof that are ready for covering with any number of different types of construction material. The joint of the present invention enables economic and rapid construction of emergency housing units following natural disasters and provides means for economical housing in under privileged countries of the world.

What is claimed is:

1. A multi-directional structural joint including,
a base member comprising intersecting perpendicular planar plates where each of the plates terminate in a peripheral edge, and
a plurality of spaced apart cylindrical studs, each having a longitudinal axis, and mounted radially on the peripheral edge of at least one of the plates where the longitudinal axis of each stud is coplanar with the plate on which it is mounted.

2. The joint of claim 1 where the longitudinal axes of antipodal studs are coincidental.

3. The joint of claim 1 where the longitudinal axes of at least two of the studs are mutually perpendicular.

4. The joint of claim 1 where the longitudinal axes of at least two of the studs are at 45° angles to one another.

5. The joint of claim 1 where the longitudinal axes of the studs intersect at a point.

6. The joint of claim 1 where the plates are polygonal in shape.

7. The joint of claim 1 where the plates are in the form of regular octagons.

8. A structural framework including,
an interconnecting joint having a base member comprising intersecting perpendicular planar plates where each of the plates terminate in a peripheral edge, and
a plurality of spaced apart cylindrical studs, each having a longitudinal axis, and mounted radially on the peripheral edge of at least one of the plates where the longitudinal axis of each stud is coplanar with the plate on which it is mounted.
at least one tubular component having an end portion adapted to receive a stud, said end portion having diametrically opposed peripheral slots sized to snugly engage the plate on which the received stud is mounted.
